(19) United States
(12) Patent Application Publication
(10) Pub. No.: US 2014/0186059 A1
(43) Pub. Date: Jul. 3, 2014

(54) SHEET CONVEYING APPARATUS

(71) Applicant: Takashi SUZUKI, Nagoya-shi (JP)

(72) Inventor: Takashi SUZUKI, Nagoya-shi (JP)

(73) Assignee: BROTHER KOGYO KABUSHIKI KAISHA, Nagoya-shi (JP)

(21) Appl. No.: 14/076,500

(22) Filed: Nov. 11, 2013

(30) Foreign Application Priority Data
Dec. 27, 2012 (JP) 2012-283868

(51) Int. Cl. G03G 15/00; B65H 5/06; B65H 7/12

(52) U.S. Cl. CPC G03G 15/6573; B65H 7/12; B65H 5/06; G03G 15/80
USPC 399/16; 271/265.01; 271/110

(57) ABSTRACT

A sheet conveying apparatus includes a sheet conveyance path, a conveying unit configured to convey a sheet along the sheet conveyance path in a sheet conveying direction, a sensor configured to output a signal dependent on whether the sheet exists at a specific position on the sheet conveyance path, and a control device configured to, when it is determined that a particular condition is satisfied before it is determined that the sheet exists at the specific position, control the conveying unit to convey the sheet, which is being conveyed in the conveying path, until when it is determined that the sheet exists at the specific position, and control the conveying unit to stop conveying the sheet when it is determined that the sheet exists at the specific position.

### CROSS-REFERENCE TO RELATED APPLICATION

This application claims priority from Japanese Patent Application No. 2012-283868, filed on Dec. 27, 2012, the entire subject matter of which is incorporated herein by reference.

### TECHNICAL FIELD

Aspects of the present invention relate to a sheet conveying apparatus which conveys a sheet.

### BACKGROUND

In a printer which prints an image on a sheet or a scanner which reads an image of a sheet, a sheet conveying apparatus which automatically conveys the sheet has been used. When a power supply off key is operated or anomaly is detected, the sheet conveying apparatus can stop conveying the sheet even before job processing is completed.

For example, JP-A-H08-76666 discloses a technique about sheet conveyance in a sheet conveying apparatus. Specifically, JP-A-H08-76666 discloses a copier which, when a power supply off instruction is received, keeps conveying a sheet and turns off a power supply once becoming a state where a sheet discharge sensor does not detect a sheet.

### SUMMARY

However, the above technique has following problems. That is, in the above technique, even when an instruction to stop the sheet conveyance, such as a power supply off instruction, is received, the conveyance of the sheet cannot be stopped until the sheet is discharged to an outside of the apparatus. Therefore, it takes time to actually stop the conveying operation. In the meantime, when the sheet conveyance is stopped immediately after the instruction to stop the sheet conveyance is received, a sheet left in the apparatus might be overlooked. In this case, when the sheet conveyance is resumed, the left sheet might cause a sheet jam.

Accordingly, an aspect of the present invention is to provide a sheet conveying apparatus capable of stopping sheet conveyance at an early stage without overlooking a sheet in the apparatus when a condition of stopping the sheet conveyance is satisfied.

According to an illustrative embodiment of the present invention, there is provided a sheet conveying apparatus including a sheet conveyance path, a conveying unit, a sensor, and a control device. The conveying unit is configured to convey a sheet along the sheet conveyance path in a sheet conveying direction. The sensor is configured to output a signal dependent on whether the sheet exists at a specific position on the sheet conveyance path. The control device is configured to determine whether the sheet exists at the specific position on the sheet conveyance path based on the signal output by the sensor, determine whether a first particular condition for stopping conveyance of the sheet is satisfied before it is determined that the sheet exists at the specific position; and when it is determined that the first particular condition is satisfied, control the conveying unit to convey the sheet, which is being conveyed in the sheet conveyance path, until when it is determined that the sheet exists at the specific position, and control the conveying unit to stop conveying the sheet when it is determined that the sheet exists at the specific position.

According to the above configuration, the sheet conveying apparatus stops the sheet conveyance before the sheet is discharged and after the sheet is conveyed to the specific position at which a signal is output by the sensor. Therefore, it is possible to stop the sheet conveyance at an early stage, compared to a configuration where the sheet conveyance is stopped after the sheet is discharged. Also, even when the sheet is left in the apparatus, the sheet conveyance is stopped after the sheet is conveyed to the specific position of the sensor. Therefore, it is possible to reduce a possibility that the left sheet is overlooked at resumption of the sheet conveyance.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 illustrates a configuration of a printer according to an illustrative embodiment;

FIG. 2 is a block diagram showing an electrical configuration of the printer;

FIG. 3 is a flowchart showing a sequence of conveyance processing;

FIG. 4 is a flowchart showing a sequence of conveyance stop processing according to a first illustrative embodiment;

FIG. 5 is a flowchart showing a sequence of discharge processing from a fixing nip portion;

FIG. 6 is a flowchart showing a sequence of conveyance start processing according to the first illustrative embodiment;

FIG. 7 is a flowchart showing a sequence of conveyance stop processing according to a second illustrative embodiment;

FIG. 8 is a flowchart showing a sequence of storing processing related on a fixing nip portion;

FIG. 9 is a flowchart showing a sequence of conveyance start processing according to the second illustrative embodiment; and

FIG. 10 is a flowchart showing a sequence of power supply mode switching processing.

### DETAILED DESCRIPTION

Hereinafter, illustrative embodiments of the present invention will be specifically described with reference to the accompanying drawings. In the illustrative embodiments, the inventive concept of the present invention is applied to a printer including a sheet conveying function. That is, a printer 100 of this illustrative embodiment is an example of a sheet conveying apparatus.

### Configuration of Printer

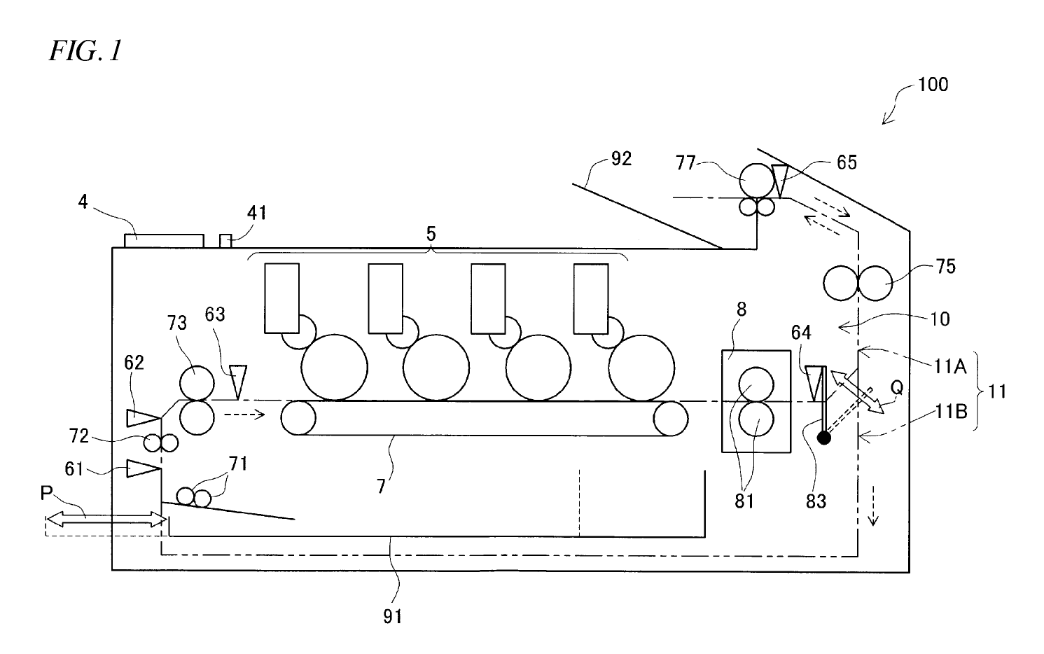

As shown in FIG. 1, the printer 100 includes therein a printing unit 10 which prints an image on a sheet, and an operation panel 4 and a power supply switch 41 provided on an upper surface thereof. The printing unit 10 includes a process unit 5 which forms a toner image on a sheet by an electrophotographic method, a conveyance belt 7 which conveys a sheet along the process unit 5, and a fixing unit 8 which fixes the formed toner image onto the sheet. The operation panel 4 includes a liquid crystal display, a start key, a stop key and the like. The process unit 5 is an example of an image forming unit.

The printer 100 is provided at its lower part with a sheet feeding tray 91 which accommodates therein sheets to be printed. As shown with an arrow P in FIG. 1, the sheet feeding tray 91 can be opened and closed by a user. An opened state of the sheet feeding tray 91 is a state where the sheet feeding tray 91 is pulled out from a main body of the printer 100. When the sheet feeding tray 91 is at the opened state, the printer 100 cannot feed a sheet from the sheet feeding tray 91. On the other hand, a closed state of the sheet feeding tray 91 is a state where the sheet feeding tray 91 is fully mounted to the main body of the printer 100. Also, the printer 100 is provided at its upper part with a sheet discharge tray 92.

Also, the printer 100 is provided therein with a conveyance path 11 which is a conveyance path of a sheet. The printer 100 includes, as the conveyance path 11, a one-sided conveyance path 11A and a reverse conveyance path 11B. The one-sided conveyance path 11A extends from the sheet feeding tray 91 to the sheet discharge tray 92 via the process unit 5 and the fixing unit 8. In the meantime, the reverse conveyance path 11B is branched from the one-sided conveyance path 11A at an exit of the fixing unit 8, passes below the sheet feeding tray 91 and merges with the one-sided conveyance path 11A at an upstream side of the process unit 5. In FIG. 1, the one-sided conveyance path 11A is shown with a dashed-dotted line, and the reverse conveyance path 11B is shown with a dashed-two dotted line. Also, a sheet conveying direction in the conveyance path 11 is shown with a dotted arrow. The conveyance path 11, the one-sided conveyance path 11A and the reverse conveyance path 11B are examples of a sheet conveyance path.

The printer 100 includes a plurality of conveyance members on the conveyance path 11. The conveyance members include a conveyance belt 7, feeder rollers 71, conveyance rollers 72, registration rollers 73, first sheet discharge rollers 75, and second sheet discharge rollers 77. The conveyance members convey a sheet at respective position. The conveyance belt 7, the feeder rollers 71, the registration rollers 73, the first sheet discharge rollers 75 and the second sheet discharge rollers 77 are examples of a conveying unit.

The feeder rollers 71 feed a sheet from the sheet feeding tray 91 to the conveyance path 11. The conveyance rollers 72 are arranged downstream of the feeder rollers 71 and upstream of the registration rollers 73 in the sheet conveying direction. The registration rollers 73 are arranged upstream of the conveyance belt 7 in the sheet conveying direction and send the sheet towards the conveyance belt 7. The conveyance belt 7 conveys the sheet along the process unit 5.

The first sheet discharge rollers 75 are arranged between the fixing unit 8 and the second sheet discharge rollers 77. The second sheet discharge rollers 77 are arranged at an exit facing the sheet discharge tray 92. The first sheet discharge rollers 75 and the sheet discharge rollers 77 are rollers which can be reversed. Further, the first sheet discharge rollers 75 and the sheet discharge rollers 77 rotate in a forward direction and a reverse direction while synchronizing with each other. For example, at duplex printing, a sheet which passes through the one-sided conveyance path 11A and is printed on one surface thereof is conveyed until a trailing end of the sheet reaches the vicinity of the first sheet discharge rollers 75 and then enters the reverse conveyance path 11B with a conveying direction thereof being reversed by cooperation of the first sheet discharge rollers 75 and the second sheet discharge rollers 77.

The fixing unit 8 of the printer 100 is arranged downstream of the process unit 5 in the sheet conveying direction. The fixing unit 8 includes therein a pair of rollers 81. The sheet on which a toner image is formed by the process unit 5 is conveyed to the fixing unit 8 and passes through a nip portion of the pair of rollers 81.

The toner image is heated and pressed by the pair of rollers 81 in the fixing unit 8 and is thus fixed on the sheet. Before a printing operation starts, the printer 100 preheats the fixing unit 8 to reach an appropriate fixing temperature. The pair of rollers 81 of the printer 100 is configured such that the rollers 81 do not convey a sheet until the preheating is appropriately performed.

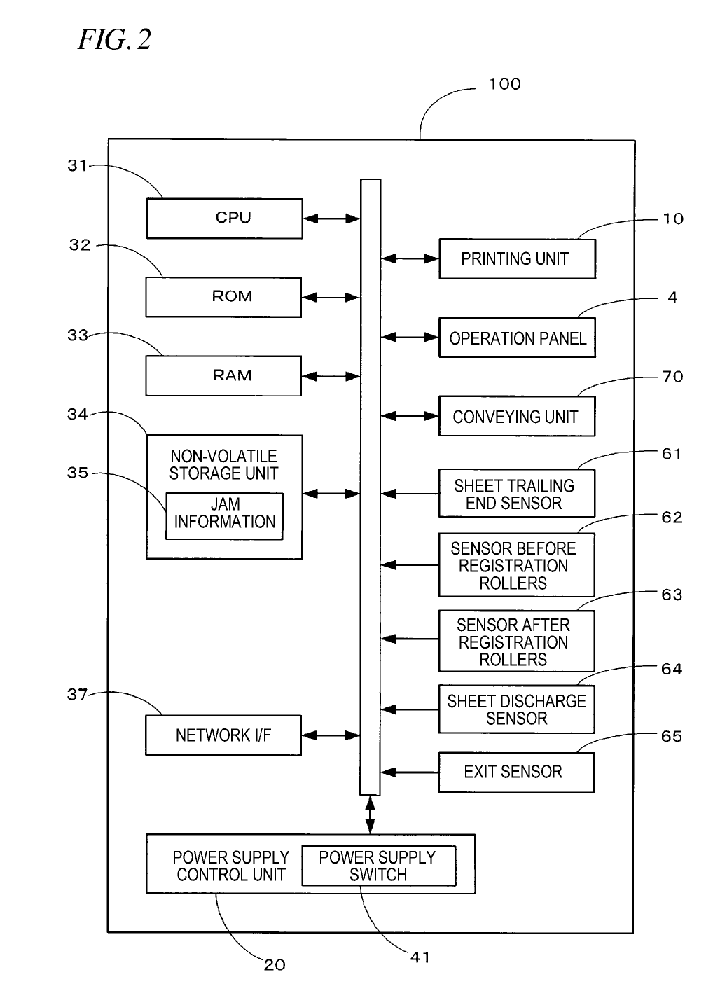

The pair of rollers 81 of the printer 100 also conveys the sheet and is thus an example of the conveying unit. Also, the pair of rollers 81 is an example of a pair of rotary members. Meanwhile, in the below descriptions, the conveyance belt 7, the feeder rollers 71, the conveyance rollers 72, the registration rollers 73, the first sheet discharge rollers 75, the second sheet discharge rollers 77 and the fixing unit 8 are collectively referred to as a conveying unit 70 (refer to FIG. 2) when it is not necessary to particularly distinguish them.

The printer 100 includes a fixing cover 83, which can be opened and closed by a user, at a downstream side of the fixing unit 8 in the sheet conveying direction. The fixing cover 83 can be opened and closed as shown with an arrow Q in FIG. 1. For example, when a sheet is jammed at the fixing unit 8, the fixing cover 83 is opened by a user. The user can remove the jammed sheet from an outside through a portion where the fixing cover 83 is opened.

The printer 100 includes sensors 61 to 65 at respective positions on the conveyance path 11. Specifically, the printer 100 includes a sheet trailing end sensor 61, a sensor 62 before the registration rollers 73, a sensor 63 after the registration rollers 73, a sheet discharge sensor 64, and an exit sensor 65. Each of the sensors 61 to 65 outputs a signal dependent on whether a sheet exists at each specific position on the conveyance path 11. That is, the respective sensors 61 to 65 output different signals depending on whether a sheet exists at the respective specific positions. Therefore, the printer 100 can detect whether a sheet exists at the respective specific positions based on the output signals of the sensors 61 to 65. Meanwhile, in the below descriptions, the specific positions of the respective sensors 61 to 65 are referred to as detection positions of the respective sensors 61 to 65. Further, an output indicating that a sheet exists is referred to as “on”, and an output indicating that no sheet exists is referred to as “off”.

Among the sensors 61 to 65 of the printer 100, the sensor 62, the sensor 63 and the exit sensor 65 are dedicated sensors, and the sheet trailing end sensor 61 and the sheet discharge sensor 64 are multi-use sensors. The on/off outputs of the dedicated sensor are not changed by a factor other than whether a sheet exists at a detection position. That is, the dedicated sensor cannot be used to detect a factor other than whether a sheet exists at a detection position. Therefore, the printer 100 can recognize whether a sheet exists at a detection position by an on or off output of each dedicated sensor.

On the other hand, an output of the multi-use sensor is also changed by a factor other than whether a sheet exists at a detection position. That is, the multi-use sensor can be also used to detect a factor other than whether a sheet exists at a detection position. Therefore, the multi-use sensor outputs an on signal not only when a sheet exists at a detection position but also when another factor is satisfied even though no sheet exists at the detection position. Therefore, even when an on output of the multi-use sensor is detected, the reliability that a sheet exists at the detection position is lower, compared to the dedicated sensor.

Specifically, a detection position of the sheet trailing end sensor 61, which is a multi-use sensor, is between the feeder rollers 71 and the conveyance rollers 72 on the conveyance path 11. The sheet trailing end sensor 61 can become on or off, depending on the opened/closed state of the sheet feeding tray 91. Specifically, at lease one of when the sheet feeding tray 91 is at the opened state and when a sheet exists at the detection position, the sheet trailing end sensor 61 becomes on. When the sheet feeding tray 91 is at the closed state and no sheet exists at the detection position, the sheet trailing end sensor 61 becomes off.

Also, a detection position of the sheet discharge sensor 64, which is another multi-use sensor, is between the fixing unit 8 and the first sheet discharge rollers 75 on the conveyance path 11. The sheet discharge sensor 64 also becomes on or off depending on the opened/closed state of the fixing cover 83. At least one of when the fixing cover 83 is at the opened state and when a sheet exists at the detection position, the sheet discharge sensor 64 becomes on. When the fixing cover 83 is at the closed state and no sheet exists at the detection position, the sheet discharge sensor 64 becomes off.

In the meantime, the sensor 62 is a dedicated sensor having a detection position between the conveyance rollers 72 and the registration rollers 73 on the conveyance path 11. The sensor 63 is a dedicated sensor having a detection position between the registration rollers 73 and the process unit 5 on the conveyance path 11. The exit sensor 65 is a dedicated sensor having a detection position between the first sheet discharge rollers 75 and the second sheet discharge rollers 77 on the conveyance path 11.

### Sheet Conveying Direction

Subsequently, the sheet conveying direction in the printer 100 is described. In FIG. 1, the sheet conveying direction is shown with the dotted arrow. The printer 100 can execute a one-sided printing and a duplex printing. In the case of the one-sided printing, a sheet is conveyed along the one-sided conveyance path 11A. The sheet is fed from the sheet feeding tray 91, is formed thereon with a toner image in the process unit 5, is fixed in the fixing unit 8 and is then discharged to the sheet discharge tray 92. Therefore, in the case of the one-sided printing, the sheet conveying direction matches an order of the sheet trailing end sensor 61→the sensor 62→the sensor 63→the sheet discharge sensor 64→the exit sensor 65.

On the other hand, in the case of the duplex printing, an image is printed on one surface, like the one-sided printing, and is also printed on a backside. That is, after the sheet, on which the one-sided printing is completed, comes out from the fixing unit 8, the sheet conveying direction is reversed by the first sheet discharge rollers 75 and the second sheet discharge rollers 77, and the sheet is then conveyed to the reverse conveyance path 11B. Then, the sheet is returned to the one-sided conveyance path 11A, so that the front and back surfaces thereof is reversed and again passes through the process unit 5. The sheet again passes through the fixing unit 8 and is then discharged to the sheet discharge tray 92. That is, in the case of the duplex printing, the sheet is conveyed in order of the one-sided conveyance path 11A, the reverse conveyance path 11 B and the one-sided conveyance path 11 A. Therefore, the sheet conveying direction matches an order of the sheet trailing end sensor 61→the sensor 62→the sensor 63→the sheet discharge sensor 64→the exit sensor 65→the sheet trailing end sensor 61→the sensor 62→the sensor 63→the sheet discharge sensor 64→the exit sensor 65.

### Electrical Configuration of Printer

Subsequently, an electrical configuration of the printer 100 is described. As shown in FIG. 2, the printer 100 has a CPU 31, a ROM 32, a RAM 33 and a non-volatile storage unit 34. The printer 100 further includes a network interface 37 which is a communication interface for connection to an external device.

The ROM 32 stores therein a variety of control programs for controlling the printer 100, a variety of settings, initial values and the like. The RAM 33 is used as a work area to which the various control programs are loaded or a storage area which temporarily stores therein data. In response to the control program read out from the ROM 32, the CPU 31 stores a result of the processing in the RAM 33 or non-volatile storage unit 34 and controls respective constitutional elements of the printer 100. For example, the CPU 31 receives the output signals of the sensors 61 to 65 to control the printing unit 10, the operation panel 4 and the conveying unit 70. The CPU 31 is an example of a control device.

The non-volatile storage unit 34 stores therein jam information 35. The jam information 35 includes information indicating whether a sheet jam occurs. Specifically, when it is determined that a jam occurs in the apparatus, the printer 100 stores information indicating that a sheet jam occurs in the jam information 35. Also, when it is determined that the jam is resolved, the printer 100 stores information indicating that no jam occurs in the jam information 35. When the information indicating that a sheet jam occurs is stored, the printer 100 does not convey a sheet. The non-volatile storage unit 34 which stores therein the jam information 35 is an example of a storage unit.

The network interface 37 is connected to an external device such as PC by a LAN and the like. For example, the printer 100 can receive and print image data from the external device connected through the network interface 37.

### Power Supply Control

Subsequently, power supply control of the printer 100 is described. As shown in FIG. 2, the printer 100 has a power supply control unit 20 which controls power supply to the various constitutional elements and a power supply switch 41.

The power supply control unit 20 includes the power supply switch 41. The power supply control unit 20 is electrically connected to the CPU 31.

The printer 100 has a power supply mode (an example of a regular mode) in which power is supplied to all the constitutional elements and a power saving mode (an example of a saving mode) in which power supply to at least the printing unit 10 is interrupted to thus reduce power consumption, compared to the power supply mode. That is, a lower power is supplied in the power saving mode than in the power supply mode. In the power supply mode, the CPU 31 can execute a variety of controls by using the ROM 32, the RAM 33, the non-volatile storage unit 34 and the like. Also, in the power supply mode, the printer 100 supplies power to all of the printing unit 10, the operation panel 4 and the conveying unit 70 and can perform a printing operation. The printer 100 operates in the power supply mode just after the activation thereof.

During an operation in the power supply mode, when a condition for switching to the power saving mode is satisfied, the printer 100 switches to the power saving mode. In the power saving mode of this illustrative embodiment, the power supply to at least the fixing unit 8 is interrupted. Thereby, while the power consumption is suppressed compared to the power supply mode, a printing operation is disabled. The switching of the power supply to the respective constitutional elements is performed by the power supply control unit 20.

In the meantime, the power supply to the power supply control unit 20 continues even in the power saving mode. The power supply control unit 20 includes a sensor for detecting that the power supply switch 41 is pressed and receives a user operation on the power supply switch 41 even in the power saving mode. While the printer 100 operates in the power saving mode, when the printer 100 receives the pressing of the power supply switch 41, the printer 100 resumes the power supply to all the constitutional elements including the printing unit 10 and switches to the power supply mode. Even after switching to the power supply mode, the printer 100 cannot perform a printing operation until the preheating of the fixing unit 8 is completed.

The switching condition of causing the printer 100 to switch from the power supply mode to the power saving mode includes three conditions of pressing of the power supply switch 41, reception of a switch command from an external apparatus such as PC, and reception of a time event which is issued at a time set as a switch time. When at least one of the three conditions is satisfied, the printer 100 switches from the power supply mode to the power saving mode. In the meantime, the switch condition of causing the printer 100 to switch from the power saving mode to the power supply mode may include pressing of the power supply switch 41 or non-operating time continuing for predetermined time or longer, for example.

### Conveyance Stop Control of Printer

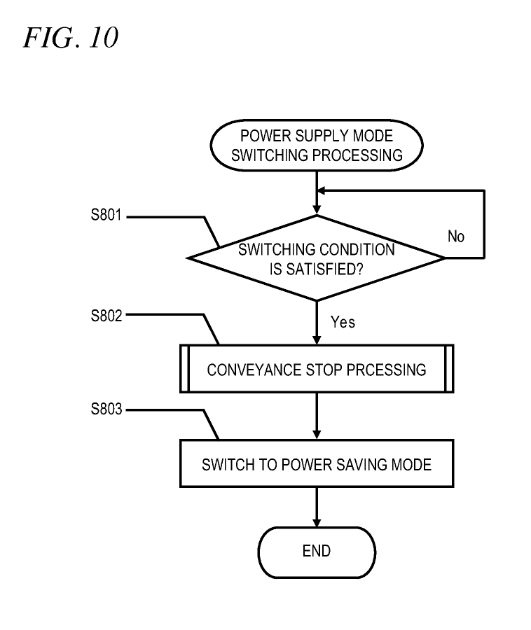

In the below, conveyance stop control of the printer 100 is described. When a sheet is being conveyed at a time when a stop condition of stopping sheet conveyance is satisfied, the printer 100 conveys the sheet and then stops it at an appropriate position. One of the stop conditions is the switch condition from the power supply mode to the power saving mode. That is, referring to FIG. 10 showing a sequence of power supply mode switching processing, when a sheet is being conveyed in the apparatus at a time when the switch condition from the power supply mode to the power saving mode is satisfied (S801: Yes), the printer 100 executes conveyance stop processing (S802) which will be described later, and then the printer 100 is switched into the power saving mode (S803). Herein, the stop condition may be an input of a power supply off key, reception of a stop command from an external apparatus, reception of a time event that is issued at time set as stop time, failure of a laser diode and failure of a fixing device.

On the other hand, when no sheet is being conveyed at a time when the stop condition is satisfied, the printer 100 immediately executes appropriate end processing and stops. The end processing includes storing processing about an apparatus state, power supply off processing based on a sequence and the like when the power supply state is the power saving mode.

### Conveyance Processing

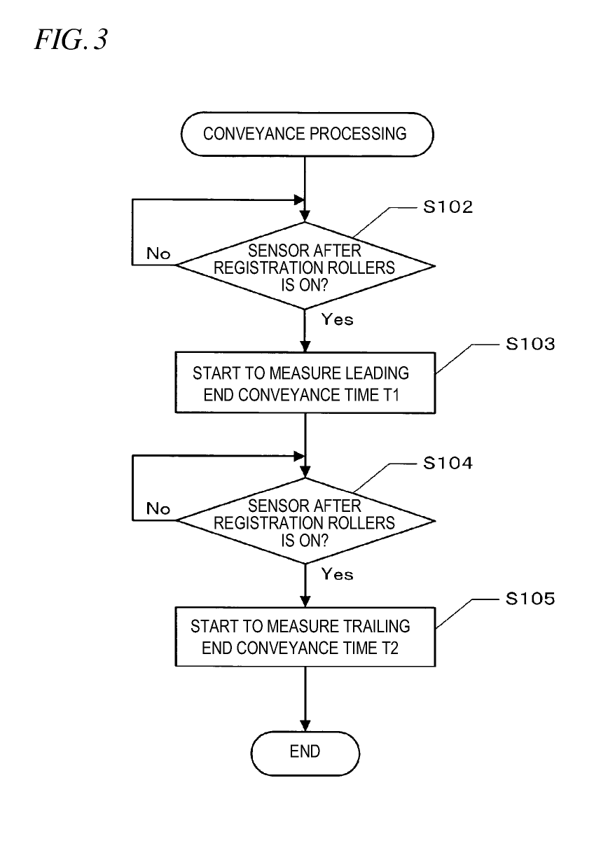

Subsequently, a variety of processing for implementing the conveyance stop control is described. First, a sequence of sheet conveyance processing which is executed in the printer 100 is described with reference to a flowchart of FIG. 3. This conveyance processing is executed by the CPU 31 when a print instruction is received and the sheet conveyance is thus started. The conveyance processing is executed commonly when conveyance stop processing according to a first illustrative embodiment and conveyance stop processing according to a second illustrative embodiment is executed.

After the conveyance processing starts, the CPU 31 determines whether the sensor 63 is on (S102). When it is determined that the sensor 63 is not on (S102: No), the CPU 31 stands by until the sensor 63 becomes on. When a leading end of the sheet reaches the detection position of the sensor 63, the sensor 63 becomes on.

When it is determined that the sensor 63 becomes on (S102: Yes), the CPU 31 starts to measure a leading end conveyance time t1 by a timer (S103). The leading end conveyance time t1 is elapsed time after the leading end of the sheet passes through the sensor 63. In an area from the detection position of the sensor 63 until the sheet passes through the fixing unit 8, a conveyance speed of the sheet is substantially constant. Therefore, the CPU 31 can determine whether the leading end of the sheet reaches the fixing unit 8, i.e., whether the sheet is sandwiched in the fixing nip portion by acquiring an elapsed time from a timing when the sensor 63 becomes on.

Then, the CPU 31 determines whether the sensor 63 becomes off (S104). When it is determined that the sensor 63 is kept at the on state (S104: No), the CPU 31 stands by until the sensor 63 becomes off. When a trailing end of the sheet reaches the detection position of the sensor 63, the sensor 63 becomes off.

When it is determined that the sensor 63 becomes off (S 104: Yes), the CPU 31 starts to measure a trailing end conveyance time t2 (S 105). The CPU 31 can determine whether a trailing end of the sheet reaches the fixing unit 8 by acquiring an elapsed time from a timing when the sensor 63 becomes off. The description of the conveyance processing is over, but the sheet is further conveyed even thereafter in accordance with the operation of the printing unit 10 and the like.

### First Illustrative Embodiment

### Conveyance Stop Processing

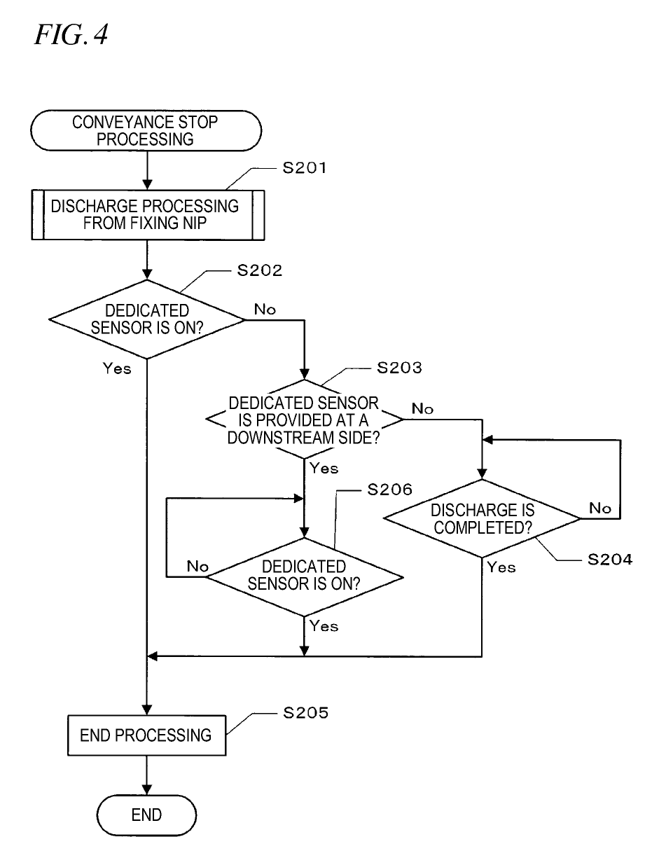

Subsequently, a sequence of the conveyance stop processing according to a first illustrative embodiment is described with reference to the flowchart of FIG. 4. The conveyance stop processing is executed in the power supply mode when the stop condition such as a switch condition to the power saving mode is satisfied after the print instruction is received until the printing is completed. That is, the conveyance stop processing is executed by the CPU 31 when the stop condition is satisfied at a state where a sheet is being conveyed in the printer 100.

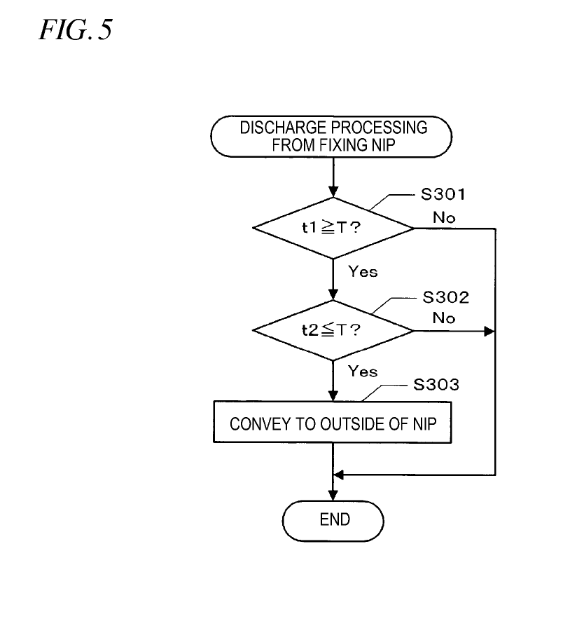

In the conveyance stop processing of the first illustrative embodiment, the CPU 31 first executes discharge processing from a fixing nip portion (S201). The discharge processing is to avoid stopping the sheet conveyance with the sheet being sandwiched in the fixing nip portion. FIG. 5 shows a sequence of the discharge processing which is executed in S201.

In the discharge processing, the CPU 31 first refers to the times t1, t2 measured in S103 and 5105 of the conveyance processing. Then, the CPU 31 compares the acquired times t1, t2 with a predetermined time T. The time T is a time which is consumed to convey the sheet from the sensor 63 to the fixing unit 8.

Specifically, the CPU 31 first determines whether the leading end conveyance time t1 is the time T or longer (S301). When it is determined that the leading end conveyance time t1 is shorter than the time T (S301: No), a sheet with a leading end having reached the fixing nip portion does not exists. When a sheet having reached the fixing nip portion dose not exist, the CPU 31 ends the discharge processing. On the other hand, when it is determined that the leading end conveyance time t1 is the time T or longer (S301: Yes), the CPU 31 compares the trailing end conveyance time t2 with the time T.

Then, the CPU 31 determines whether the trailing end conveyance time t2 is the time T or shorter (S302). When it is determined that the trailing end conveyance time t2 is longer than the time T (S302: No), the trailing end of the sheet has got through the fixing nip portion. That is, it can be determined that no sheet is sandwiched in the fixing nip portion. Therefore, the CPU 31 ends the discharge processing.

On the other hand, when it is determined that the trailing end conveyance time t2 is the time T or shorter (S302: Yes), there is a possibility that the sheet is sandwiched in the fixing nip portion. When it is determined that the sheet is sandwiched in the fixing nip portion, the CPU 31 conveys the sheet to the outside of the fixing nip portion (S303). For example, the CPU 31 continues to convey the sheet until the trailing end conveyance time t2 becomes the time T, thereby conveying the sheet to the outside of the fixing nip portion. Thereby, the printer 100 of this illustrative embodiment can avoid stopping the sheet conveyance with the sheet being sandwiched in the nip portion.

As described above, the pair of rollers 81 in the fixing unit 8 does not convey the sheet until the fixing unit 8 is appropriately preheated. Therefore, when the sheet conveyance is stopped with the sheet being sandwiched in the fixing nip portion, the fixing unit is preheated with the sheet being sandwiched, so that the sheet may be discolored, which is not preferable. In this illustrative embodiment, since the printer 100 conveys the sheet to the outside of the fixing nip portion before stopping, the fixing unit 8 is not preheated with the sheet being sandwiched in the fixing nip portion. Accordingly, the discharge processing ends.

Returning to FIG. 4, the CPU 31 determines whether the sheet exists at the detection position of the dedicated sensors 62, 63, 65. That is, the CPU 31 determines whether any one of the dedicated sensors 62, 63, 65 is on (S202). When it is determined that all the dedicated sensors 62, 63, 65 are not on (S202: No), the CPU 31 determines whether any one of the dedicated sensors 62, 63, 65 is disposed at the more downstream side than the position of the sheet being conveyed in the conveyance direction (S203). Since the printer 100 recognizes the passing position of the sheet by the respective sensors 61 to 65 during the printing operation, the printer 100 can determine whether any of the dedicated sensors is disposed at the downstream side.

When it is determined that no dedicated sensor is disposed at the downstream side of the sheet position (S203: No), the CPU 31 keeps conveying the sheet until the sheet discharge is completed. Then, the CPU 31 determines whether the sheet discharge is completed (S204). When it is determined that the sheet discharge is not completed (S204: No), the CPU 31 keeps conveying the sheet. When it is determined that the sheet discharge is completed (S204: Yes), the CPU 31 executes the end processing (S205). For example, the CPU 31 stops the power supply to the components, to which the power supply should be stopped in the power saving mode. Then, the CPU 31 ends the conveyance stop processing.

On the other hand, when it is determined that any one of the dedicated sensors 62, 63, 65 is disposed at the downstream side of the sheet position (S203: Yes), the CPU 31 conveys the sheet until that dedicated sensor becomes on. That is, when the closest sensor disposed at downstream side is the multi-use sensor, the sheet is not stopped at the multi-use sensor and is conveyed to the dedicated sensor even though the dedicated sensor is disposed at the more downstream side. Thus, the CPU 31 keeps conveying the sheet and determines whether the dedicated sensor becomes on (S206).

When it is determined that the dedicated sensor is not on (S206: No), the CPU 31 conveys the sheet until the dedicated sensor becomes on. When it is determined that any one of the dedicated sensors becomes on (S206: Yes), the CPU 31 executes the end processing (S205). That is, the sheet conveyance is stopped after the sheet is conveyed to the detection position of the dedicated sensor. After the processing of 5201, when the sheet exists at the detection position of the dedicated sensor (S202: Yes), the end processing is immediately executed (S205). After S205, the CPU 31 ends the conveyance stop processing.

### Conveyance Start Processing

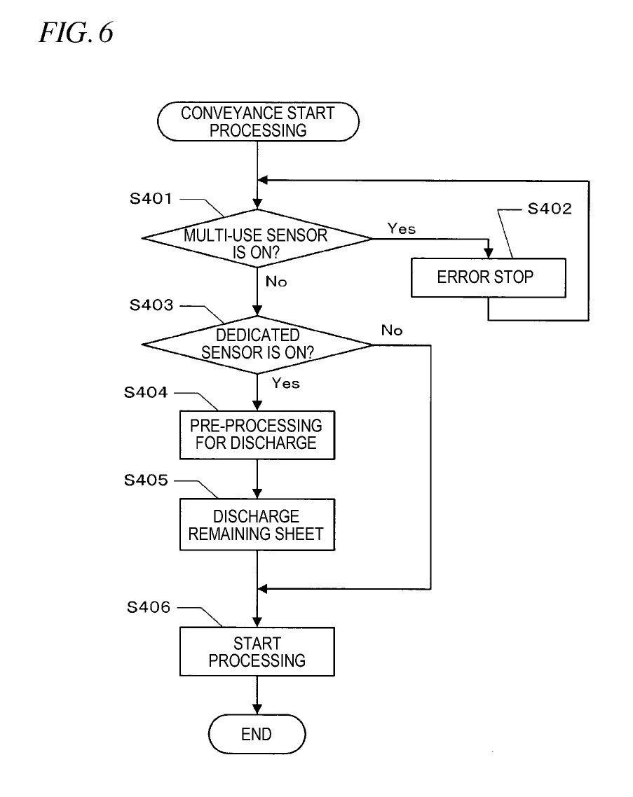

Subsequently, a sequence of the conveyance start processing according to the first illustrative embodiment is described with reference to the flowchart of FIG. 6. The conveyance start processing is executed by the CPU 31 when a start condition of starting the sheet conveyance is satisfied in the printer 100 which has stopped the sheet conveyance by the above-described conveyance stop processing. For example, the start condition is a case where the power supply switch 41 of the printer 100 is pressed in the power saving mode. Herein, the start condition may include an input of a power supply on key, reception of a start command from an external apparatus, reception of a time event that is issued at time set as start time, reception of a job, failure solution of a laser diode and failure solution of a fixing device.

In the conveyance start processing, the CPU 31 first determines whether at least one of the multi-use sensors 61, 64 is on (S401). When it is determined that at least one of the multi-use sensors 61, 64 is on (S401: Yes), the CPU 31 stops due to an error (S402). When the multi-use sensor 61 is on, this means that the sheet feeding tray 91 is at the opened state. When the multi-use sensor 64 is on, this means that the fixing cover 83 is at the opened state. The printer 100 stops and stands by until both the sheet feeding tray 91 and the fixing cover 83 are at the closed state.

When it is determined that all the multi-use sensors 61, 64 are not on (S401: No), the CPU 31 determines whether any one of the dedicated sensors 62, 63, 65 is on (S403). When it is determined that any one of the dedicated sensors 62, 63, 65 is on (S403: Yes), there is a high possibility that the sheet is in the apparatus. Thus, the CPU 31 executes pre-processing for discharging the remaining sheet (S404). The pre-processing includes the preheating of the fixing unit 8, for example. When the pre-processing is completed, the CPU 31 discharges the sheet (S405). In the meantime, when the sheet is positioned at the downstream side of the fixing unit 8, the CPU 31 may execute the pre-processing (S404) and the discharge processing (S405) in parallel. When the sheet is discharged, the CPU 31 executes start processing of the respective units (S406). Then, the CPU 31 ends the conveyance start processing.

On the other hand, when it is determined that all the dedicated sensors 62, 63, 65 are off (S403: No), there is a high possibility that there is no sheet in the apparatus. Therefore, the CPU 31 immediately executes the start processing (S406). Then, the CPU 31 ends the conveyance start processing.

In the printer 100 of the first illustrative embodiment, when the sheet exists in the conveyance path 11 at a time when the stop condition, such as the switch condition from the power supply mode to the power saving mode, is satisfied, the sheet is conveyed to the position at which any one of the dedicated sensors 62, 63, 65 becomes on, and the sheet conveyance is then stopped. Therefore, the sheet conveyance can be stopped at an early stage, compared to a configuration where the conveyed sheet is discharged to the outside of the apparatus and the sheet conveyance is then stopped. Also, according to the conveyance stop processing of the first illustrative embodiment, when the sheet is sandwiched in the fixing nip portion at a time when the stop condition is satisfied, the sheet is conveyed to the outside of the fixing nip portion. Therefore, in the conveyance start processing of the first illustrative embodiment, the processing becomes simple because it is not necessary to consider a possibility that the sheet is sandwiched in the fixing nip portion.

### Second Illustrative Embodiment

### Conveyance Stop Processing

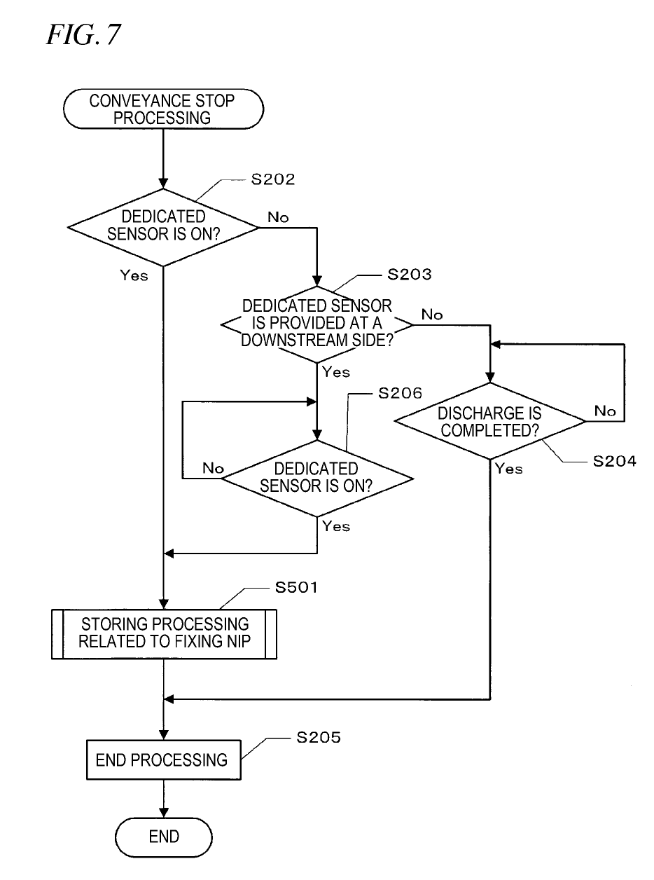

Subsequently, a sequence of conveyance stop processing according to a second illustrative embodiment in the printer 100 is described with reference to the flowchart of FIG. 7. In the conveyance stop processing of the second illustrative embodiment, the sheet conveyance is stopped even when the conveyed sheet is sandwiched in the fixing nip portion. This is different from the first illustrative embodiment where the sheet is conveyed until the conveyed sheet gets through the fixing nip portion. In the meantime, the same processing as the first illustrative embodiment is denoted with the same reference numerals and the descriptions thereof are omitted.

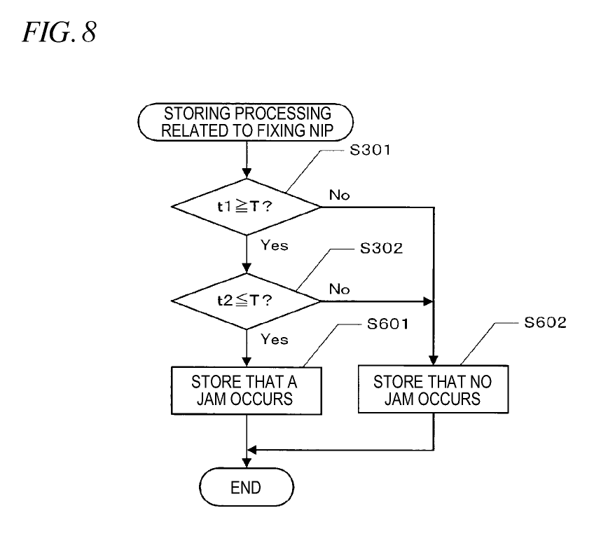

In the conveyance stop processing of this illustrative embodiment, the CPU 31 conveys the sheet until any one of the dedicated sensors 62, 63, 65 becomes on (S202, S203, S206). When it is determined that any one of the dedicated sensors 62, 63, 65 becomes on (S202: Yes or S206: Yes), the CPU 31 executes storing processing related to the fixing nip portion (S501). The storing processing is to store whether the sheet is sandwiched in the fixing nip portion. FIG. 8 shows a sequence of the storing processing which is executed in S501.

In the storing processing, the CPU 31 determines whether the leading end conveyance time t1 is the time T or longer (S301) and determines whether the trailing end conveyance time T2 is the time T or shorter (S302), like the above-described discharge processing from the fixing nip portion. Based on this determination, the CPU 31 determines whether the conveyed sheet is sandwiched in the fixing nip portion.

When it is determined that the conveyed sheet is sandwiched in the fixing nip portion (S302: Yes), the CPU 31 stores information indicating that a sheet jam occurs, in the jam information 35 of the non-volatile storage unit 34 (S601). On the other hand, when it is determined that the conveyed sheet is not sandwiched in the fixing nip portion (S301: No or S302: No), the CPU 31 stores information indicating that no sheet jam occurs, in the jam information 35 of the non-volatile storage unit 34 (S602). With this, the CPU 31 ends the storing processing.

Returning to FIG. 7, the CPU 31 executes the end processing (S205). On the other hand, when it is determined that no dedicated sensor is disposed at the downstream side of the conveyed sheet (S203: No), the CPU 31 discharges the sheet and executes the end processing (S205). Accordingly, the CPU 31 ends the conveyance stop processing of the second illustrative embodiment.

### Conveyance Start Processing

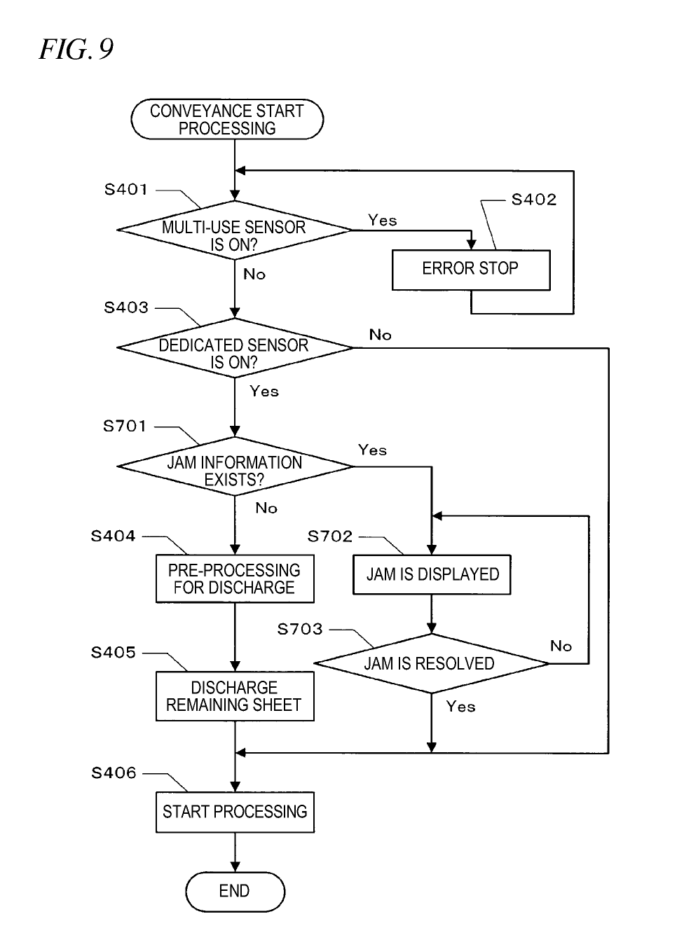

Subsequently, a sequence of conveyance start processing according to the second illustrative embodiment is described with reference to the flowchart of FIG. 9. Herein, the same processing as the first illustrative embodiment is denoted with the same reference numerals and the descriptions thereof are omitted.

In the conveyance start processing of the second illustrative embodiment, when the multi-use sensor is on (S401: Yes), the CPU 31 stops (S402), like the first illustrative embodiment. When the multi-use sensor is off (S401: No), the CPU 31 checks the dedicated sensors. When no dedicated sensor is on (S403: No), the CPU 31 executes the start processing (S406) and ends the conveyance start processing. On the other hand, when it is determined that any one of the dedicated sensors is on (S403: Yes), the CPU 31 determines whether the information indicating that a sheet jam occurs is stored in the jam information 35 of the non-volatile storage unit 34 (S701).

When it is determined that the information indicating that no sheet jam occurs, is stored (S701: No), no sheet is sandwiched in the fixing nip portion. However, there is a high possibility that the sheet remains at a position other than the fixing nip portion, from the results of the sensors. Thus, like the first illustrative embodiment, the CPU 31 executes the pre-processing (S404) and discharges the sheet (S405). Further, the CPU executes the start processing (S406). Then, the CPU 31 ends the conveyance start processing.

On the other hand, when it is determined that the information indicating that a sheet jam occurs, is stored (S701: Yes), there is a possibility that the sheet is sandwiched in the fixing nip portion. Thus, the CPU 31 does not start the sheet conveyance at that state and displays information indicating that there is a possibility of a jam occurring in the fixing nip portion, on the operation panel 4 (S702). Alternatively, the CPU 31 displays information prompting a user to remove the sheet sandwiched in the fixing nip portion.

The CPU 31 keeps displaying the information (S702) until the user removes the sheet to thus resolve the jam (S703: No). When the sheet is removed by the user (S703: Yes), the CPU 31 executes the start processing (S406). Then, the CPU 31 ends the conveyance start processing. Accordingly, even though the sheet conveyance is stopped with the conveyed sheet is sandwiched in the fixing nip portion, the fixing unit 8 is not preheated until the sheet is appropriately removed. Therefore, there is no concern that the sheet is discolored due to the preheating.

According to the conveyance stop processing of the second illustrative embodiment, it can be expected that the sheet conveyance is stopped at an early stage when the stop condition is satisfied, like the first illustrative embodiment. Also, in this illustrative embodiment, even though the sheet is sandwiched in the fixing nip portion, the information indicating a sheet jam occurring in the apparatus is stored and the sheet is not discharged. Thus, it can be expected that the sheet conveyance is stopped at an earlier stage than the first illustrative embodiment. In the conveyance start processing of the second illustrative embodiment, the information prompting the user to remove the sheet sandwiched in the fixing nip portion is displayed only when the information indicating a sheet jam occurring is stored, and the fixing unit 8 is not preheated until the sheet is removed. Therefore, there is no concern that the fixing unit is preheated with the sheet being sandwiched.

As described above, the printer 100 includes the plurality of sensors 61 to 65 on the conveyance path 11 of the sheet. The printer 100 conveys the sheet to the position at which a sensor is on and then stops the sheet conveyance when a sheet exists on the conveyance path 11 at a time when the stop condition, such as a switch condition from the power supply mode to the power saving mode, is satisfied. Therefore, it is possible to stop the sheet conveyance at an early stage, compared to a configuration where the conveyed sheet is discharged to the outside of the apparatus and the sheet conveyance is then stopped. Also, when the conveyance is resumed by the switching condition from the power saving mode to the power supply mode, for example, it is possible to recognize the position of the sheet by the outputs of the sensors. Therefore, it can be expected that the sheet remaining in the apparatus will not be an obstacle to resumption of the sheet conveyance.

While the present invention has been shown and described with reference to certain illustrative embodiments thereof, it will be understood by those skilled in the art that various changes in form and details may be made therein without departing from the spirit and scope of the invention as defined by the appended claims.

For example, the inventive concept of the present invention can be applied not only to the printer but also to an apparatus having a sheet conveying function such as a copier, a scanner, a FAX and the like.

Also, in the above illustrative embodiments, the sheet is conveyed to the position at which the dedicated sensor becomes on and the sheet conveyance is then stopped. However, the sheet conveyance may be stopped at a position at which the multi-use sensor becomes on. In this case, the “dedicated sensor” in S202, 5203 and S206 may be simply referred to as ‘sensor’. Thereby, it is possible to stop the sheet conveyance at an earlier stage. However, it is preferable to perform the determination by the dedicated sensor because there is no influence by other factors and it is possible to detect whether a sheet exists more securely.

Further, for example, the stop condition is not limited to the switch to the power saving mode and may be a condition of stopping the sheet conveyance. For example, for an apparatus having a battery, the stop condition may be that a main power supply becomes off In this case, the start condition is that the main power supply becomes on.

Further, for example, in the above illustrative embodiments, the fixing unit 8 includes the pair of rollers 81. However, the present invention is not limited thereto. One or both of the pair of rollers 81 may be a cylindrical rotary member and the inventive concept of the present invention may be also applied to an apparatus having a fixing film, a fixing belt and the like.

Further, the processing described in the illustrative embodiment may be executed by hardware such as a single CPU, a plurality of CPUs, an ASIC and the like or a combination thereof. Also, the processing described in the illustrative embodiment may be implemented in a variety of modes such as a recording medium having a program for executing the processing recorded therein, a method thereof and the like.

What is claimed is:

1. A sheet conveying apparatus comprising:
a sheet conveyance path;
a conveying unit configured to convey a sheet along the sheet conveyance path in a sheet conveying direction;
a sensor configured to output a signal dependent on whether the sheet exists at a specific position on the sheet conveyance path; and
a control device configured to:
determine whether the sheet exists at the specific position on the sheet conveyance path based on the signal output by the sensor;
determine whether a first particular condition for stopping conveyance of the sheet is satisfied before it is determined that the sheet exists at the specific position; and
when it is determined that the first particular condition is satisfied, control the conveying unit to convey the sheet, which is being conveyed in the sheet conveyance path, until when it is determined that the sheet exists at the specific position, and control the conveying unit to stop conveying the sheet when it is determined that the sheet exists at the specific position.

2. The sheet conveying apparatus according to claim 1,
wherein the sensor comprises a plurality of sensors disposed on the sheet conveyance path, and each sensor is configured to output a signal dependent on whether the sheet exists at each specific position, respectively, and
wherein the control device is further configured to:
when it is determined that the first particular condition is satisfied, control the conveying unit to convey the sheet until when it is determined that the sheet exists at one of the specific positions which is closest to the sheet at a downstream side of the sheet in the sheet conveying direction, and control the conveying unit to stop conveying the sheet when it is determined that the sheet exists at the one of the specific positions.

3. The sheet conveying apparatus according to claim 1,
wherein the sensor is a dedicated sensor configured to output a signal only dependent on whether the sheet exists at the specific position.

4. The sheet conveying apparatus according to claim 1,
wherein the sensor comprises a plurality of sensors disposed on the sheet conveyance path, and each sensor is configured to output a signal dependent on whether the sheet exists at each specific position, respectively,
wherein the plurality of sensors include a dedicated sensor configured to output a signal only dependent on whether the sheet exists at a first specific position, and a multi-use sensor configured to output a signal dependent on whether the sheet exists at a second specific position and dependent on a factor other than whether the sheet exists at the second specific position, and
wherein the control device is further configured to:
when it is determined that the first particular condition is satisfied, control the conveying unit to convey the sheet until when it is determined that the sheet exists at the first specific position which is closest to the sheet at a downstream side of the sheet in the sheet conveying direction, and control the conveying unit to stop conveying the sheet when it is determined that the sheet exists at the first specific position.

5. The sheet conveying apparatus according to claim 4,
wherein the control device is further configured to:
control the conveying unit to convey the sheet to outside of the sheet conveying apparatus when no dedicated sensor is disposed at the downstream side of the sheet in the sheet conveying direction.

6. The sheet conveying apparatus according to claim 1,
wherein the control device is further configured to:
determine whether a second particular condition for starting conveyance of the sheet is satisfied;
when the second particular condition is satisfied, determine whether the sheet exists at the specific position; and
control the conveying unit to convey the sheet to outside of the sheet conveying apparatus when it is determined that the sheet exists at the specific position.

7. The sheet conveying apparatus according to claim 6, further comprising:
a storage unit configured to store therein information indicating whether a sheet jam occurs,
wherein the control device is further configured to:
determine whether a sheet jam occurs based on the information stored in the storage unit; and
control the convey unit to convey the sheet in the sheet conveyance path to the outside of the sheet conveying apparatus when it is determined that no sheet jam occurs, and control the convey unit not to convey the sheet to the outside of the sheet conveying apparatus when it is determined that the sheet jam occurs.

8. The sheet conveying apparatus according to claim 7, further comprising:
an image forming unit configured to form a toner image on a sheet; and
a fixing unit provided downstream of the image forming unit in the sheet conveying direction and comprising a pair of rotary members, the fixing unit being configured to cause the sheet to pass through a nip portion between the pair of rotary members to fix the toner image formed by the image forming unit on the sheet, wherein the control device is further configured to:
determine whether the sheet exists in the nip portion based on the signal output by the sensor; and
store the information indicating that the sheet jam occurs in the storage unit when it is determined that the sheet exists in the nip portion after stopping conveying the sheet. 30

9. The sheet conveying apparatus according to claim 8,
wherein the control device configured to determine whether the sheet exists in the nip portion based on the signal output by the sensor and on a predetermined time period for conveying the sheet from the sensor to the fixing unit.

10. The sheet conveying apparatus according to claim 1, further comprising:
an image forming unit configured to form a toner image on the sheet, and
a fixing unit provided downstream of the image forming unit in the sheet conveying direction and comprising a pair of rotary members, the fixing unit being configured to cause the sheet to pass through a nip portion between the pair of rotary members to fix the toner image formed by the image forming unit on the sheet,
wherein the control device is further configured to:
determine whether the sheet exists in the nip portion based on the signal output by the sensor; and
control the conveying unit to convey the sheet until when it is determined that the sheet exists at another specific position where the sheet does not exists at the nip portion.

11. The sheet conveying apparatus according to claim 10,
wherein the control device configured to determine whether the sheet exists in the nip portion based on the signal output by the sensor and on a predetermined time period for conveying the sheet from the sensor to the fixing unit.

12. The sheet conveying apparatus according to claim 1, further comprising:
a power supply control unit configured to supply power in a regular mode and a saving mode,
wherein the power supply unit is configured to supply lower power in the saving mode than in the regular mode,
wherein the control device is further configured to:
control the power supply control unit to switch the sheet conveying apparatus from the regular mode to the saving mode,
when a third particular condition for switching to the saving mode is satisfied, determine that the first particular condition is satisfied.

13. The sheet conveying apparatus according to claim 1,
wherein the control device is configured to control the conveying unit to convey the sheet to outside of the sheet conveying apparatus, if it is determined that the first particular condition is satisfied after it is determined that the sheet exists at the specific position.
